(19) United States
(12) Patent Application Publication
(10) Pub. No.: US 2026/0318702 A1
(43) Pub. Date: Oct. 15, 2026

(54) Self-Improving Road Structure Estimation Using Aggregated Lane Graphs

(71) Applicants: Nissan North America, Inc., Franklin, TN (US); Nissan Motor Co., Ltd., Yokohama-shi (JP)

(72) Inventors: Chikao Tsuchiya, Cupertino, CA (US); Kanako Sakai, Inagi-city (JP); Dhaval Bhanderi, San Jose, CA (US); David Ilstrup, Santa Cruz, CA (US); Hsin-Min Cheng, Millbrae, CA (US); Christopher Ostafew, Mountain View, CA (US)

(21) Appl. No.: 19/179,545

(22) Filed: Apr. 15, 2025

(51) Int. Cl. G01C 21/00

(52) U.S. Cl. CPC G01C 21/3822

(57) ABSTRACT

A plurality of local lane graphs corresponding to at least one road portion are obtained. Lane-level map data corresponding to the at least one road portion is created by aggregating the plurality of local lane graphs. The lane-level map data is then output.

### TECHNICAL FIELD

This application relates to road structure estimation, and more particularly relates to self-improving road structure estimation using aggregated lane graphs.

### BACKGROUND

A vehicle may traverse a portion of a vehicle transportation network (e.g., a road). Traversing the portion of the vehicle transportation network may include generating or capturing, such as by a sensor of the vehicle, data, such as data representing an operational environment, or a portion thereof, of the vehicle. Traversing the portion of the vehicle transportation network may include performing an action of autonomous driving in response to the captured data. The action may be selected using artificial intelligence (e.g., trained machine-learning models) or other decision-making models.

### SUMMARY

In one embodiment, a method for road structure estimation is provided. In this embodiment, the method includes obtaining a plurality of local lane graphs corresponding to at least one road portion, creating lane-level map data corresponding to the at least one road portion by aggregating the plurality of local lane graphs, and outputting the lane-level map data.

In another embodiment, a system for road structure estimation is provided. In this embodiment, the system includes one or more memories and one or more processors configured to execute instructions stored in the one or more memories to cause the system to instantiate a vectorized local lane graph engine configured to generate a plurality of local lane graphs corresponding to at least one road portion, instantiate a lane graph aggregator configured to create lane-level map data corresponding to the at least one road portion by aggregating the plurality of local lane graphs, and output the lane-level map data.

In yet another embodiment, an apparatus for road structure estimation is provided. In this embodiment, the apparatus includes one or more memories and one or more processors configured to execute instructions stored in the one or more memories to cause the apparatus to obtain a plurality of local lane graphs corresponding to at least one road portion, create lane-level map data corresponding to the at least one road portion by aggregating the plurality of local lane graphs, and output the lane-level map data

These and other aspects, features, elements, implementations, and embodiments of the methods, apparatus, procedures, and algorithms disclosed herein are described in further detail hereafter.

### BRIEF DESCRIPTION OF THE DRAWINGS

The disclosed technology is best understood from the following detailed description when read in conjunction with the accompanying drawings. It is emphasized that, according to common practice, the various features of the drawings may not be to scale. For example, the dimensions of various features may be expanded or reduced for clarity. Further, like reference numbers refer to like elements throughout the drawings unless otherwise noted.

FIG. 1 is a diagram of an example of a vehicle in which the aspects, features, and elements disclosed herein may be implemented.

FIG. 2 is a diagram of an example of a portion of a vehicle transportation and communication system in which the aspects, features, and elements disclosed herein may be implemented.

FIG. 3 shows a block diagram of an example of a computing device capable of performing functions described later herein.

FIG. 4 is a block schematic diagram of an example of a system for self-improving road structure estimation using aggregated lane graphs, in accordance with the present disclosure.

FIG. 5 is a data flow diagram of an example associated with self-improving road structure estimation using aggregated lane graphs, in accordance with the present disclosure.

FIGS. 6A-6C are diagrams associated with a process for lane graph aggregation, in accordance with the present disclosure.

FIG. 7 is a flow diagram illustrating an example of a technique for road structure estimation, in accordance with the present disclosure.

### DETAILED DESCRIPTION

A vehicle, such as an autonomous vehicle (AV), or a semi-autonomous vehicle, may traverse a portion of a vehicle transportation network. The vehicle may include one or more sensors and traversing the vehicle transportation network may include the sensors generating or capturing sensor data, such as sensor data corresponding to an operational environment of the vehicle, or a portion thereof. For example, the sensor data may include information corresponding to one or more external objects, such as pedestrians, remote vehicles, other objects within the vehicle operational environment, vehicle transportation network geometry, or a combination thereof. As used herein, an AV encompasses a semi-autonomous vehicle.

During autonomous driving, and at different time steps (e.g., at every time step), some component (e.g., a decision-making module or model such as a reasoning module, an inference module, or the like) of the AV may determine a respective action for controlling the AV in response to sensor information. Thus, at a high level, the component of the AV uses inputs (e.g., sensor data) and produces an output (e.g., the action to control the AV) where the output can be an action for controlling the AV.

The component can be a single component (e.g., module, model, circuitry, etc.), multiple cooperating components, or a command arbitration module (e.g., an executor or an autonomous vehicle operational management controller) that receives inputs (e.g., candidate actions) from multiple components and selects one of the candidate actions as the selected action for controlling the AV.

Road structure estimation is a component of advanced driver assistance systems (ADAS) and autonomous driving technologies. As these systems become increasingly sophisticated, the need for accurate and up-to-date road information has grown. Conventional approaches to road structure estimation may rely on high-definition (HD) maps and precise localization techniques. However, these methods face challenges in real-world applications due to the dynamic nature of road environments and the limitations of current mapping technologies.

One of the technical challenges in road structure estimation is the dependency on HD maps, which may involve frequent updates to maintain accuracy. The process of creating and maintaining HD maps can be resource-intensive, involving specialized equipment. Moreover, even minor changes in road infrastructure, such as temporary construction or lane closures, can render portions of an HD map obsolete. This can create a burden on map providers and vehicle manufacturers to update and distribute new map data, leading to potential inconsistencies and delays in providing accurate road information to autonomous vehicles.

Another issue arises from the reliance on precise localization techniques. Current systems often require centimeter-level accuracy to effectively utilize HD maps for road structure estimation. However, achieving such high precision consistently in diverse environments and weather conditions remains a technical challenge. Factors such as GPS signal interference, sensor inaccuracies, and environmental obstructions can lead to localization errors, which in turn propagate through the road structure estimation process. These errors can result in incorrect lane assignments, misidentification of road boundaries, and other mistakes that compromise the safety and efficiency of autonomous driving systems.

Implementations of this disclosure address problems such as these by obtaining a plurality of local lane graphs corresponding to at least one road portion, creating lane-level map data corresponding to the at least one road portion by aggregating the plurality of local lane graphs, and outputting the lane-level map data. This approach may facilitate the generation of accurate and up-to-date road structure information without relying solely on high-definition maps or precise localization techniques.

In some implementations, the lane-level map data may be output to a map embedding engine configured to generate an embedded map representation. The term "map embedding engine" refers to a computational system that generates a feature vector (embedded map representation) from polylines extracted from map data. For example, the map embedding engine may employ convolutional neural networks or transformer-based models to encode lane-level maps into feature vectors. In some implementations, graph neural networks or recurrent neural networks may be used for map representation.

The disclosure provides a technical improvement over traditional road structure estimation methods by introducing a self-improving mechanism. In some implementations, a transformer decoder of a vectorized local lane graph engine may receive the embedded map representation as input and generate the plurality of local lane graphs based on this representation and a set of birds-eye-view (BEV) features. The term "birds-eye-view features" encompasses visual or sensor data transformed into a top-down perspective, which may include information from cameras, LiDAR, or other sensors mounted on a vehicle.

To enhance the accuracy and completeness of road structure estimation, some implementations may incorporate additional map data sources. For instance, a standard definition map may be provided as input to the map embedding engine. The term "standard definition map" refers to a lower-resolution map that contains basic road network information, such as road centerlines and intersections. This may be contrasted with high-definition maps, which typically include more detailed information such as lane markings and road signs.

Some implementations include a multi-pass approach to refine and improve road structure estimation over time. In some implementations, the standard definition map may be provided as an initial input to the map embedding engine during a first pass, while the lane-level map data is output in a second pass after the first pass. This iterative process may facilitate improvement of the road structure estimation, adapting to changes in the road environment without requiring constant updates to a centralized high-definition map.

The aggregation of local lane graphs to create lane-level map data may involve processing techniques. In some implementations, this process may include dividing a portion of a standard definition map into an intersection area and an other road area, identifying sets of local lane graphs associated with each area, and creating separate lane-level map portions for the intersection area and the other road area. This approach may facilitate specialized handling of complex road structures such as intersections.

For intersection areas, the creation of lane-level map portions may involve identifying subsets of local lane graphs that cross intersection edges, determining input and output points, and applying clustering algorithms to generate a coherent representation of the intersection. The term "clustering algorithm" refers to a computational method for grouping similar data points, which in this context may be used to identify common lane entry and exit points in an intersection.

In the case of non-intersection road areas, the creation of lane-level map portions may utilize a system of "way bars" - reference lines placed perpendicular to the road direction at regular intervals. The process may involve identifying crossing points between local lane graphs and way bars, determining centroids of crossing point clusters, and connecting these centroids to form a continuous lane representation. This technique may facilitate creation of a consistent and accurate lane-level map even in areas where individual local lane graphs may contain inconsistencies or errors.

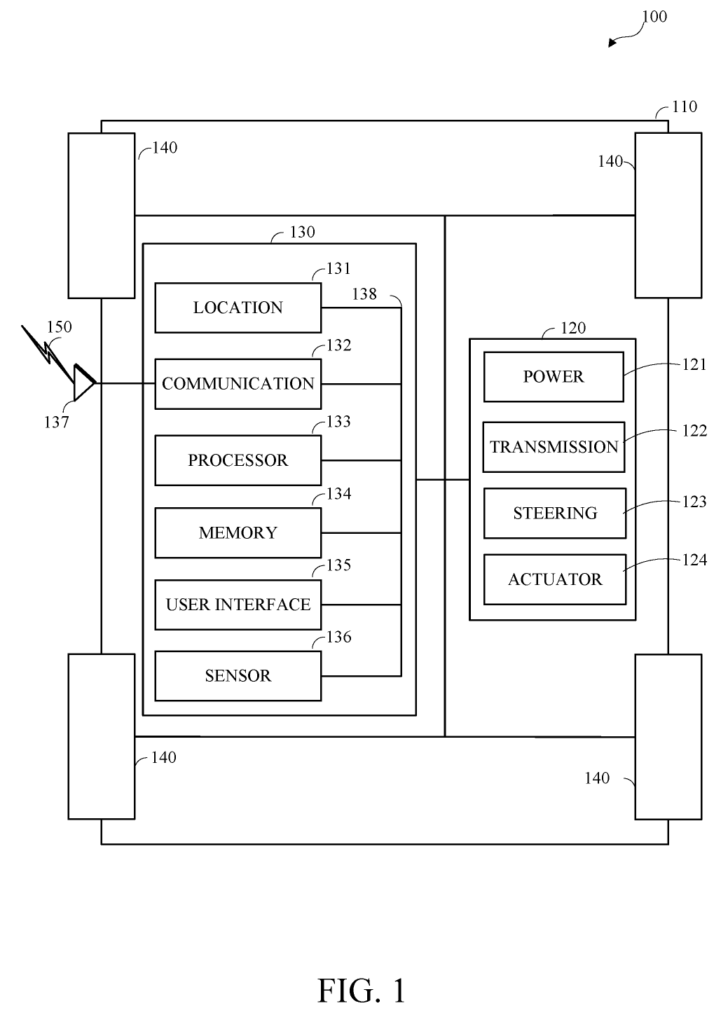

FIG. 1 is a diagram of an example of a vehicle in which the aspects, features, and elements disclosed herein may be implemented. As shown, a vehicle 100 includes a chassis 110, a powertrain 120, a controller 130, and wheels 140. Although the vehicle 100 is shown as including four wheels 140 for simplicity, any other propulsion device or devices, such as a propeller or tread, may be used. In FIG. 1, the lines interconnecting elements, such as the powertrain 120, the controller 130, and the wheels 140, indicate that information, such as data or control signals, power, such as electrical power or torque, or both information and power, may be communicated between the respective elements. For example, the controller 130 may receive power from the powertrain 120 and may communicate with the powertrain 120, the wheels 140, or both, to control the vehicle 100, which may include accelerating, decelerating, steering, or otherwise controlling the vehicle 100.

As shown, the powertrain 120 includes a power source 121, a transmission 122, a steering unit 123, and an actuator 124. Other elements or combinations of elements of a powertrain, such as a suspension, a drive shaft, axles, or an exhaust system may be included. Although shown separately, the wheels 140 may be included in the powertrain 120.

The power source 121 may include an engine, a battery, or a combination thereof. The power source 121 may be any device or combination of devices operative to provide energy, such as electrical energy, thermal energy, or kinetic energy. For example, the power source 121 may include an engine, such as an internal combustion engine, an electric motor, or a combination of an internal combustion engine and an electric motor, and may be operative to provide kinetic energy as a motive force to one or more of the wheels 140. The power source 121 may include a potential energy unit, such as one or more dry cell batteries, such as nickel-cadmium (NiCd), nickel-zinc (NiZn), nickel metal hydride (NiMH), lithium-ion (Li-ion); solar cells; fuel cells; or any other device capable of providing energy.

The transmission 122 may receive energy, such as kinetic energy, from the power source 121, and may transmit the energy to the wheels 140 to provide a motive force. The transmission 122 may be controlled by the controller 130 the actuator 124 or both. The steering unit 123 may be controlled by the controller 130 the actuator 124 or both and may control the wheels 140 to steer the vehicle. The actuator 124 may receive signals from the controller 130 and may actuate or control the power source 121, the transmission 122, the steering unit 123, or any combination thereof to operate the vehicle 100.

As shown, the controller 130 may include a location unit 131, an electronic communication unit 132, a processor 133, a memory 134, a user interface 135, a sensor 136, an electronic communication interface 137, or any combination thereof. Although shown as a single unit, any one or more elements of the controller 130 may be integrated into any number of separate physical units. For example, the user interface 135 and the processor 133 may be integrated in a first physical unit and the memory 134 may be integrated in a second physical unit. Although not shown in FIG. 1, the controller 130 may include a power source, such as a battery. Although shown as separate elements, the location unit 131, the electronic communication unit 132, the processor 133, the memory 134, the user interface 135, the sensor 136, the electronic communication interface 137, or any combination thereof may be integrated in one or more electronic units, circuits, or chips.

The processor 133 may include any device or combination of devices capable of manipulating or processing a signal or other information now-existing or hereafter developed, including optical processors, quantum processors, molecular processors, or a combination thereof. For example, the processor 133 may include one or more special purpose processors, one or more digital signal processors, one or more microprocessors, one or more controllers, one or more microcontrollers, one or more integrated circuits, one or more Application Specific Integrated Circuits, one or more Field Programmable Gate Array, one or more programmable logic arrays, one or more programmable logic controllers, one or more state machines, or any combination thereof. The processor 133 may be operatively coupled with the location unit 131, the memory 134, the electronic communication interface 137, the electronic communication unit 132, the user interface 135, the sensor 136, the powertrain 120, or any combination thereof. For example, the processor may be operatively coupled with the memory 134 via a communication bus 138.

The memory 134 may include any tangible non-transitory computer-usable or computer-readable medium, capable of, for example, containing, storing, communicating, or transporting machine readable instructions, or any information associated therewith, for use by or in connection with the processor 133. The memory 134 may be, for example, one or more solid state drives, one or more memory cards, one or more removable media, one or more read-only memories, one or more random access memories, one or more disks, including a hard disk, a floppy disk, an optical disk, a magnetic or optical card, or any type of non-transitory media suitable for storing electronic information, or any combination thereof.

The communication interface 137 may be a wireless antenna, as shown, a wired communication port, an optical communication port, or any other wired or wireless unit capable of interfacing with a wired or wireless electronic communication medium 150. Although FIG. 1 shows the communication interface 137 communicating via a single communication link, a communication interface may be configured to communicate via multiple communication links. Although FIG. 1 shows a single communication interface 137, a vehicle may include any number of communication interfaces.

The communication unit 132 may be configured to transmit or receive signals via a wired or wireless electronic communication medium 150, such as via the communication interface 137. Although not explicitly shown in FIG. 1, the communication unit 132 may be configured to transmit, receive, or both via any wired or wireless communication medium, such as radio frequency (RF), ultraviolet (UV), visible light, fiber optic, wireline, or a combination thereof. Although FIG. 1 shows a single communication unit 132 and a single communication interface 137, any number of communication units and any number of communication interfaces may be used. In some embodiments, the communication unit 132 may include a dedicated short-range communications (DSRC) unit, an on-board unit (OBU), or a combination thereof.

The location unit 131 may determine geolocation information, such as longitude, latitude, elevation, direction of travel, or speed, of the vehicle 100. For example, the location unit may include a global positioning system (GPS) unit, such as a Wide Area Augmentation System (WAAS) enabled National Marine -Electronics Association (NMEA) unit, a radio triangulation unit, or a combination thereof. The location unit 131 can be used to obtain information that represents, for example, a current heading of the vehicle 100, a current position of the vehicle 100 in two or three dimensions, a current angular orientation of the vehicle 100, or a combination thereof.

The user interface 135 may include any unit capable of interfacing with a person, such as a virtual or physical keypad, a touchpad, a display, a touch display, a heads-up display, a virtual display, an augmented reality display, a haptic display, a feature tracking device, such as an eye-tracking device, a speaker, a microphone, a video camera, a sensor, a printer, or any combination thereof. The user interface 135 may be operatively coupled with the processor 133, as shown, or with any other element of the controller 130. Although shown as a single unit, the user interface 135 may include one or more physical units. For example, the user interface 135 may include an audio interface for performing audio communication with a person and a touch display for performing visual and touch-based communication with the person. The user interface 135 may include multiple displays, such as multiple physically separate units, multiple defined portions within a single physical unit, or a combination thereof.

The sensor 136 may include one or more sensors, such as an array of sensors, which may be operable to provide information that may be used to control the vehicle. The sensors 136 may provide information regarding current operating characteristics of the vehicle 100. The sensor 136 can include, for example, a speed sensor, acceleration sensors, a steering angle sensor, traction-related sensors, braking-related sensors, steering wheel position sensors, eye tracking sensors, seating position sensors, or any sensor, or combination of sensors, operable to report information regarding some aspect of the current dynamic situation of the vehicle 100.

The sensor 136 may include one or more sensors operable to obtain information regarding the physical environment surrounding the vehicle 100. For example, one or more sensors may detect road geometry and features, such as lane lines, and obstacles, such as fixed obstacles, vehicles, and pedestrians. The sensor 136 can be or include one or more video cameras, laser-sensing systems, infrared-sensing systems, acoustic-sensing systems, or any other suitable type of on-vehicle environmental sensing device, or combination of devices, now known or later developed. In some embodiments, the sensors 136 and the location unit 131 may be a combined unit.

Although not shown separately, the vehicle 100 may include a trajectory controller. For example, the controller 130 may include the trajectory controller. The trajectory controller may be operable to obtain information describing a current state of the vehicle 100 and a route planned for the vehicle 100, and, based on this information, to determine and optimize a trajectory for the vehicle 100. In some embodiments, the trajectory controller may output signals operable to control the vehicle 100 such that the vehicle 100 follows the trajectory that is determined by the trajectory controller. For example, the output of the trajectory controller can be an optimized trajectory that may be supplied to the powertrain 120, the wheels 140, or both. In some embodiments, the optimized trajectory can be control inputs such as a set of steering angles, with each steering angle corresponding to a point in time or a position. In some embodiments, the optimized trajectory can be one or more paths, lines, curves, or a combination thereof.

One or more of the wheels 140 may be a steered wheel, which may be pivoted to a steering angle under control of the steering unit 123, a propelled wheel, which may be torqued to propel the vehicle 100 under control of the transmission 122, or a steered and propelled wheel that may steer and propel the vehicle 100.

A vehicle may include units, or elements, not expressly shown in FIG. 1, such as an enclosure, a Bluetooth® module, a frequency modulated (FM) radio unit, a Near Field Communication (NFC) module, a liquid crystal display (LCD) display unit, an organic light-emitting diode (OLED) display unit, a speaker, or any combination thereof.

The vehicle 100 may be an autonomous vehicle controlled autonomously, without direct human intervention, to traverse a portion of a vehicle transportation network. Although not shown separately in FIG. 1, an autonomous vehicle may include an autonomous vehicle control unit, which may perform autonomous vehicle routing, navigation, and control. The autonomous vehicle control unit may be integrated with another unit of the vehicle. For example, the controller 130 may include the autonomous vehicle control unit. The teachings herein are equally applicable to a semi-autonomous vehicle.

The autonomous vehicle control unit may control or operate the vehicle 100 to traverse a portion of the vehicle transportation network in accordance with current vehicle operation parameters. The autonomous vehicle control unit may control or operate the vehicle 100 to perform a defined operation or maneuver, such as parking the vehicle. The autonomous vehicle control unit may generate a route of travel from an origin, such as a current location of the vehicle 100, to a destination based on vehicle information, environment information, vehicle transportation network data representing the vehicle transportation network, or a combination thereof, and may control or operate the vehicle 100 to traverse the vehicle transportation network in accordance with the route. For example, the autonomous vehicle control unit may output the route of travel to the trajectory controller, and the trajectory controller may operate the vehicle 100 to travel from the origin to the destination using the generated route.

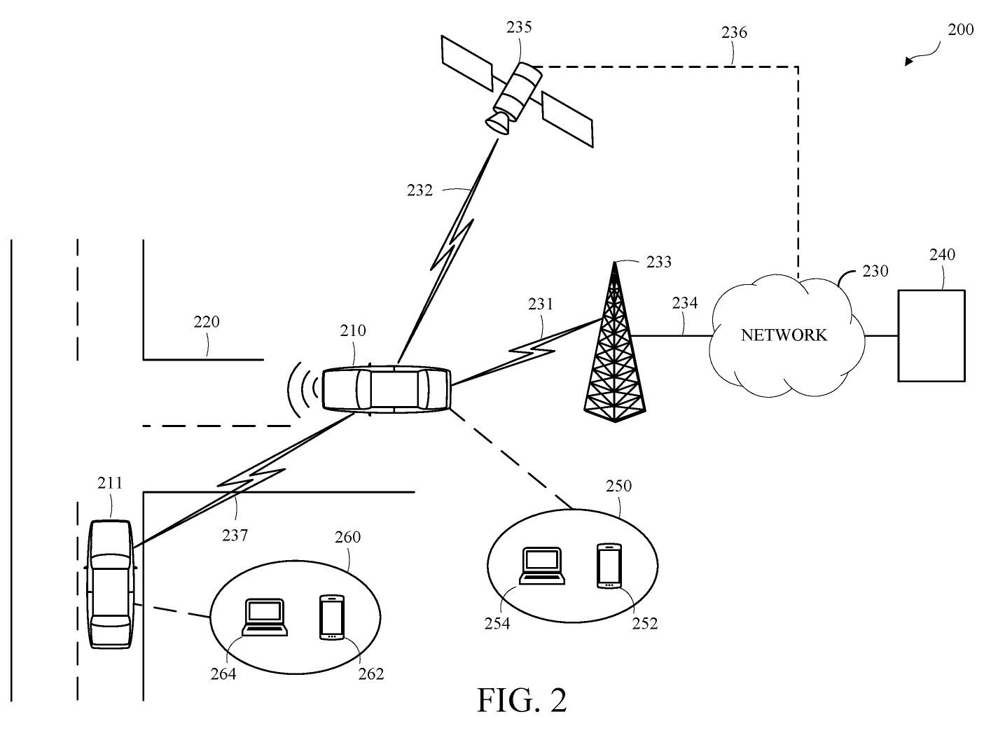

FIG. 2 is a diagram of an example of a portion of a vehicle transportation and communication system in which the aspects, features, and elements disclosed herein may be implemented. The vehicle transportation and communication system 200 may include one or more vehicles 210 and 211, such as the vehicle 100 shown in FIG. 1, which may travel via one or more portions of one or more vehicle transportation networks 220 and may communicate via one or more electronic communication networks 230. Although not explicitly shown in FIG. 2, a vehicle may traverse an area that is not expressly or completely included in a vehicle transportation network, such as an off-road area.

The electronic communication network 230 may be, for example, a multiple access system and may provide for communication, such as voice communication, data communication, video communication, messaging communication, or a combination thereof, between the vehicle 210 or 211 and one or more communication devices 240. For example, a vehicle 210 or 211 may receive information, such as information representing the vehicle transportation network 220, from a communication device 240 via the network 230.

In some embodiments, a vehicle 210 or 211 may communicate via a wired communication link (not shown), a wireless communication link 231, 232, or 237, or a combination of any number of wired or wireless communication links. For example, as shown, a vehicle 210 or 211 may communicate via a terrestrial wireless communication link 231, via a non-terrestrial wireless communication link 232, or via a combination thereof. The terrestrial wireless communication link 231 may include an Ethernet link, a serial link, a Bluetooth link, an infrared (IR) link, a UV link, or any link capable of providing for electronic communication.

A vehicle 210 or 211 may communicate with another vehicle 210 or 211. For example, a host, or subject, vehicle (HV) 210 may receive one or more automated inter-vehicle messages, such as a basic safety message (BSM), from a remote, or target, vehicle (RV) 211, via a direct communication link 237, or via a network 230. For example, the remote vehicle 211 may broadcast the message to host vehicles within a defined broadcast range, such as 300 meters. In some embodiments, the host vehicle 210 may receive a message via a third party, such as a signal repeater (not shown) or another remote vehicle (not shown). A vehicle 210 or 211 may transmit one or more automated inter-vehicle messages periodically, based on, for example, a defined interval, such as 100 milliseconds.

Automated inter-vehicle messages may include vehicle identification information, geospatial state information, such as longitude, latitude, or elevation information, geospatial location accuracy information, kinematic state information, such as vehicle acceleration information, yaw rate information, speed information, vehicle heading information, braking system status information, throttle information, steering wheel angle information, or vehicle routing information, or vehicle operating state information, such as vehicle size information, headlight state information, turn signal information, wiper status information, transmission information, or any other information, or combination of information, relevant to the transmitting vehicle state. For example, transmission state information may indicate whether the transmission of the transmitting vehicle is in a neutral state, a parked state, a forward state, or a reverse state.

The vehicle 210 may communicate with the communications network 230 via an access point 233. The access point 233, which may include a computing device, may be configured to communicate with a vehicle 210, with a communication network 230, with one or more communication devices 240, or with a combination thereof via wired or wireless communication links 231 or 234. For example, the access point 233 may be a base station, a base transceiver station (BTS), a Node-B, an enhanced Node-B (eNode-B), a Home Node-B (HNode-B), a wireless router, a wired router, a hub, a relay, a switch, or any similar wired or wireless device. Although shown as a single unit in FIG. 2, an access point may include any number of interconnected elements.

The vehicle 210 may communicate with the communications network 230 via a satellite 235 or other non-terrestrial communication device. The satellite 235, which may include a computing device, may be configured to communicate with a vehicle 210, with a communication network 230, with one or more communication devices 240, or with a combination thereof via one or more communication links 232 or 236. Although shown as a single unit in FIG. 2, a satellite may include any number of interconnected elements.

An electronic communication network 230 may be any type of network configured to provide for voice, data, or any other type of electronic communication. For example, the electronic communication network 230 may include a local area network (LAN), a wide area network (WAN), a virtual private network (VPN), a mobile or cellular telephone network, the Internet, or any other electronic communication system. The electronic communication network 230 may use a communication protocol, such as the transmission control protocol (TCP), the user datagram protocol (UDP), the internet protocol (IP), the real-time transport protocol (RTP) the HyperText Transport Protocol (HTTP), or a combination thereof. Although shown as a single unit in FIG. 2, an electronic communication network may include any number of interconnected elements.

The vehicle 210 may identify a portion or condition of the vehicle transportation network 220. For example, the vehicle 210 may include one or more on-vehicle sensors, such as sensor 136 shown in FIG. 1, which may include a speed sensor, a wheel speed sensor, a camera, a gyroscope, an optical sensor, a laser sensor, a radar sensor, a sonic sensor, or any other sensor or device or combination thereof capable of determining or identifying a portion or condition of the vehicle transportation network 220. The sensor data may include lane line data, remote vehicle location data, or both.

The vehicle 210 may traverse a portion or portions of one or more vehicle transportation networks 220 using information communicated via the network 230, such as information representing the vehicle transportation network 220, information identified by one or more on-vehicle sensors, or a combination thereof.

Although for simplicity FIG. 2 shows two vehicles 210, 211, one vehicle transportation network 220, one electronic communication network 230, and one communication device 240, any number of vehicles, networks, or computing devices may be used. The vehicle transportation and communication system 200 may include devices, units, or elements not shown in FIG. 2. Although the vehicle 210 is shown as a single unit, a vehicle may include any number of interconnected elements.

Although the vehicle 210 is shown communicating with the communication device 240 via the network 230, the vehicle 210 may communicate with the communication device 240 via any number of direct or indirect communication links. For example, the vehicle 210 may communicate with the communication device 240 via a direct communication link, such as a Bluetooth communication link.

In some embodiments, a vehicle 210 or 211 may be associated with an entity 250 or 260, such as a driver, operator, or owner of the vehicle. In some embodiments, an entity 250 or 260 associated with a vehicle 210 or 211 may be associated with one or more personal electronic devices 252, 254, 262, or 264, such as a smartphone 252 or 262 or a computer 254 or 264. In some embodiments, a personal electronic device 252, 254, 262, or 264 may communicate with a corresponding vehicle 210 or 211 via a direct or indirect communication link. Although one entity 250 or 260 is shown as associated with a respective vehicle 210 or 211 in FIG. 2, any number of vehicles may be associated with an entity and any number of entities may be associated with a vehicle.

The vehicle transportation network 220 shows only navigable areas (e.g., roads), but the vehicle transportation network may also include one or more unnavigable areas, such as a building, one or more partially navigable areas, such as a parking area or pedestrian walkway, or a combination thereof. The vehicle transportation network 220 may also include one or more interchanges between one or more navigable, or partially navigable, areas. A portion of the vehicle transportation network 220, such as a road, may include one or more lanes and may be associated with one or more directions of travel.

A vehicle transportation network, or a portion thereof, may be represented as vehicle transportation network data. For example, vehicle transportation network data may be expressed as a hierarchy of elements, such as markup language elements, which may be stored in a database or file. For simplicity, the figures herein depict vehicle transportation network data representing portions of a vehicle transportation network as diagrams or maps; however, vehicle transportation network data may be expressed in any computer-usable form capable of representing a vehicle transportation network, or a portion thereof. The vehicle transportation network data may include vehicle transportation network control information, such as direction of travel information, speed limit information, toll information, grade information, such as inclination or angle information, surface material information, aesthetic information, defined hazard information, or a combination thereof.

A portion, or a combination of portions, of the vehicle transportation network 220 may be identified as a point of interest or a destination. For example, the vehicle transportation network data may identify a building as a point of interest or destination. The point of interest or destination may be identified using a discrete uniquely identifiable geolocation. For example, the vehicle transportation network 220 may include a defined location, such as a street address, a postal address, a vehicle transportation network address, a GPS address, or a combination thereof for the destination.

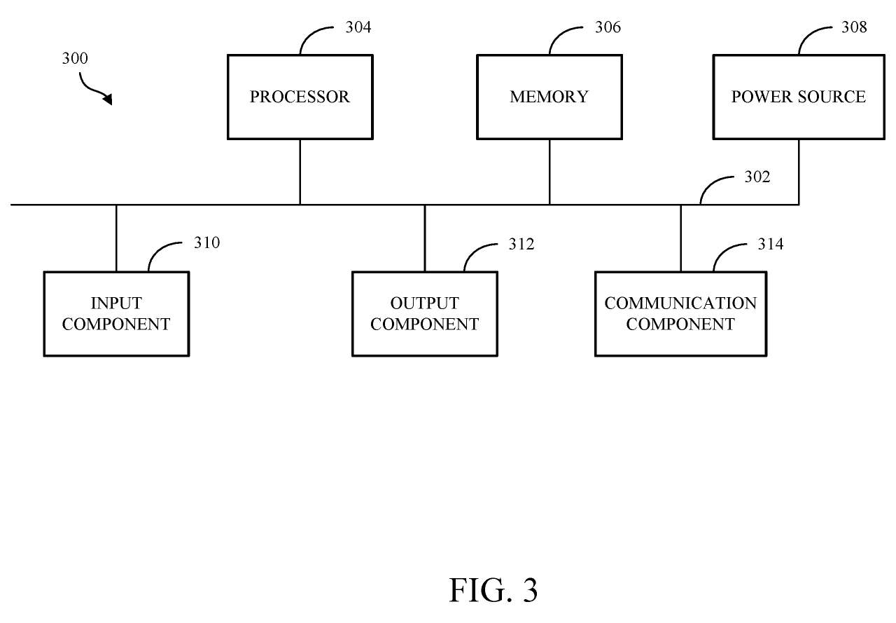

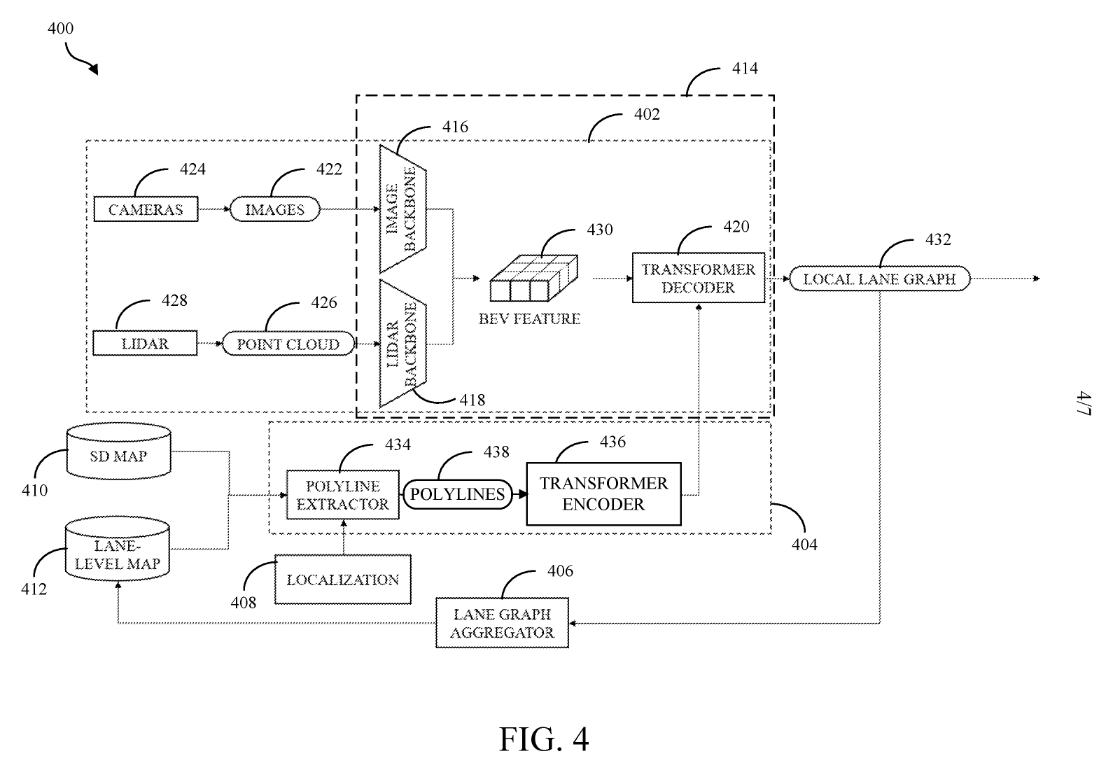

FIG. 3 shows a block diagram of an example of a computing device 300 capable of performing functions described herein. In some implementations, the computing device 300 may include a system for road structure estimation (e.g., the system 400 shown in FIG. 4) as described herein. The computing device 300 may be, be similar to, include, or be included in, an apparatus for performing one or more methods, processes, algorithms, operations, tasks, and/or techniques, as described herein. The computing device 300 may be, be similar to, include, or be included in, a controller of a vehicle (e.g., the controller 130 shown in FIG. 1), an on-board computer, or a mobile device, among other examples. The computing device 300 includes a bus 302 that interconnects various components or units, such as a processor 304, a memory 306, a power source 308, an input component 310, an output component 312, and a communication component 314, among other examples.

The processor 304 may include one or more chiplets, chips, system-on-chips (SoCs), network-on-chips (NoCs), chipsets, packages, or devices that individually or collectively constitute or comprise a processing system. The processing system includes a processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). The processor 304 may include a cache, or cache memory, for local storage of operating data or instructions.

One or more of the processors may be individually or collectively configurable or configured to perform various operations described herein. In some implementations, a single processor may perform all of the operations described as being performed by the one or more processors. In some implementations, a group of processors collectively configurable or configured to perform a set of operations may include a first set of (one or more) processors configurable or configured to perform a first operation of the set and a second processor configurable or configured to perform a second operation of the set, or may include the group of processors all being configured or configurable to perform the set of operations. The first set of processors and the second set of processors may be the same set of processors or may be different sets of processors.

The memory 306 includes one or more memory components, which may each be volatile memory or non-volatile memory, that individually or collectively constitute a memory system. The memory system may include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory,” “the memory system,” or “the memory circuitry”). The memory 306 may include non-transitory memory, transitory memory, or a combination thereof. Volatile memory may include RAM (e.g., a dynamic RAM (DRAM) module, such as a double data rate (DDR) synchronous DRAM (SDRAM)). Non-volatile memory may include a disk drive, a solid state drive, flash memory, or phase-change memory. In some implementations, the memory 306 may be distributed across multiple devices. For example, the memory 306 may include network-based memory or memory in multiple clients or servers performing the operations of those multiple devices. The memory 306 may be referred to as one or more computer-readable storage media. A computer-readable storage medium may include any storage unit (or multiple storage units) that store data or instructions that are readable by a processing system. A computer-readable storage medium may include, for example, at least one of a data repository, a data storage unit, a computer memory, a hard drive, a disk, or a random access memory.

One or more of the memories may be coupled (for example, operatively coupled, communicatively coupled, electronically coupled, or electrically coupled) with one or more of the processors and may individually or collectively store processor-executable instructions (e.g., code such as software) that, when executed by one or more of the processors, may configure or otherwise cause one or more of the processors to perform various functions or operations described herein. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise.

In some implementations, the executable instructions may include application data or an operating system, among other examples. The executable instructions may include one or more application programs, which may be loaded or copied, in whole or in part, from non-volatile memory to volatile memory to be executed by the processor 304. For example, the executable instructions may include instructions for performing techniques described in this disclosure. In some implementations, the application data may include functional programs, such as computational programs, analytical programs, or database programs, among other examples. The operating system may be, for example, Microsoft Windows®, Mac OS X®, or Linux®; an operating system for a mobile device, such as a smartphone or tablet device; or an operating system for a non-mobile device, such as a mainframe computer.

Reference to “one or more memories” should be understood to refer to any one or more memories of a corresponding device, such as the memory described in connection with FIG. 3. For example, operation described as being performed by, or data described as being stored on, one or more memories can be performed by, or stored on, respectively, the same subset of the one or more memories or different subsets of the one or more memories. Additionally or alternatively, in some examples, one or more of the processors may be preconfigured to perform various functions or operations described herein without requiring configuration by software. For example, the memory 306 may include data or instructions that are hard-wired into the processing system.

In the description herein, language describing a system, an apparatus, or a device as taking an action (such as performing, determining, initiating, receiving, calculating, deciding, computing, processing, etc.) is to be understood as describing that some appropriate component of the system, apparatus, or device is taking the action. As used herein, the term “component” is intended to be broadly construed as hardware and/or a combination of hardware and software.

The power source 308 provides power to the computing device 300. For example, the power source 308 may be an interface to an external power distribution system. In an example, the power source 308 may be a battery, such as where the computing device 300 is a mobile device or is otherwise configured to operate independently of an external power distribution system. In some implementations, the computing device 300 may include or otherwise use multiple power sources. In some such implementations, the power source 308 can be a backup battery.

The input component 310 and/or the output component 312 may include one or more input interfaces and/or output interfaces configured for facilitating communication between the computing device 300 and one or more peripheral devices such as, for example, one or more sensors, detectors, displays, input devices, or other devices configured for facilitating interaction with the computing device 300 or the environment around the computing device 300. An input device may, for example, include a positional input device, such as a mouse, touchpad, touchscreen, or the like; a keyboard; or another suitable human or machine interface device. An output device may, for example, include a display, such as a liquid crystal display, a cathode-ray tube, a light emitting diode display, or other suitable display. In some implementations, the peripherals devices may include a geolocation component, such as a global positioning system (GPS) location unit. In some examples, the peripheral devices may include a temperature sensor for measuring temperatures of components of the computing device 300, such as the processor 304.

The communication component 314 may include an interface for facilitating a connection or link to a network. The communication component 314 may include a wired network interface or a wireless network interface. The computing device 300 may communicate with other devices via the communication component 314 using one or more network protocols, such as using Ethernet, TCP, IP, power line communication, an IEEE 802.X protocol (e.g., Wi-Fi, Bluetooth, or ZigBee), infrared, visible light, general packet radio service (GPRS), global system for mobile communications (GSM), code-division multiple access (CDMA), Z-Wave, a cellular communication protocol, another protocol, or a combination thereof. For example, the computing device 300 can communicate with a database server.

The communication component 314 may include a transceiver, which may include a transmitter or a receiver. In some configurations, one or a combination of antenna(s), modem(s), multiple input multiple output (MIMO) detectors, receive processors, transmit processors, and/or the transmit MIMO processors may be included in the transceiver. The transceiver may be under control of or used by one or more processors, and in some aspects in conjunction with processor-readable code stored in the memory, to perform aspects of the methods, processes, techniques, and/or operations described herein.

Some implementations are described as including various engines, each of which is constructed, programmed, configured, or otherwise adapted, to carry out a function or set of functions. The term engine as used herein means a tangible device, component, or arrangement of components implemented using hardware, such as by an application specific integrated circuit (ASIC) or field-programmable gate array (FPGA), for example, or as a combination of hardware and software, such as by a processor-based computing platform and a set of program instructions that transform the computing platform into a special-purpose device to implement the particular functionality. An engine may also be implemented as a combination of the two, with certain functions facilitated by hardware alone, and other functions facilitated by a combination of hardware and software.

In an example, the software may reside in executable or non-executable form on a tangible machine-readable storage medium. Software residing in non-executable form may be compiled, translated, or otherwise converted to an executable form prior to, or during, runtime. In an example, the software, when executed by the underlying hardware of the engine, causes the hardware to perform the specified operations. Accordingly, an engine is physically constructed, or specifically configured (e.g., hardwired), or temporarily configured (e.g., programmed) to operate in a specified manner or to perform part or all of any operations described herein in connection with that engine.

Considering examples in which engines are temporarily configured, each of the engines may be instantiated at different moments in time. For example, where the engines comprise a general-purpose hardware processor core configured using software, the general-purpose hardware processor core may be configured as respective different engines at different times. Software may accordingly configure a hardware processor core, for example, to constitute a particular engine at one instance of time and to constitute a different engine at a different instance of time.

In certain implementations, at least a portion, and in some cases, all, of an engine may be executed on the processor(s) of one or more computers that execute an operating system, system programs, and application programs, while also implementing the engine using multitasking, multithreading, distributed (e.g., cluster, peer-peer, cloud, etc.) processing where appropriate, or other such techniques. Accordingly, each engine may be realized in a variety of suitable configurations, and should generally not be limited to any particular implementation exemplified herein, unless such limitations are expressly called out.

In addition, an engine may itself be composed of more than one sub-engines, each of which may be regarded as an engine in its own right. Moreover, in the embodiments described herein, each of the various engines corresponds to a defined functionality; however, it should be understood that in other contemplated embodiments, each functionality may be distributed to more than one engine. Likewise, in other contemplated embodiments, multiple defined functionalities may be implemented by a single engine that performs those multiple functions, possibly alongside other functions, or distributed differently among a set of engines than specifically illustrated in the examples herein.

As used herein, the term “model” encompasses its plain and ordinary meaning. A model may include, among other things, one or more engines which receive an input and compute an output based on the input.

FIG. 4 is a block diagram of an example of a system for road structure estimation. As shown, the system 400 includes a local lane graph estimator 402, a map embedding engine 404, and a lane graph aggregator 406, which are configured to interact with each other to provide self-improving road structure estimation using aggregated lane graphs. The elements of system 400 may be included in, may include, or may be implemented on one or more elements of the computing device 300, such as the processor 304 and local memory 306. In some implementations, one or more components of the system 400 may be implemented on a vehicle, such as the vehicle 100 or 210 or 211 as shown in FIGS. 1 and 2. For example, the local lane graph estimator 402 and the map embedding engine 404 may be implemented on a portion of the vehicle and the lane graph aggregator 406 may be implemented on a cloud server. As another example, the local lane graph estimator 402, the map embedding engine 404, and the lane graph aggregator 406 may all be implemented on a vehicle. Although the system 400 is shown and described as including the local lane graph estimator 402, the map embedding engine 404, and the lane graph aggregator 406, the system 400 may include fewer, more, and/or different components.

The local lane graph estimator 402 may be configured to generate local lane graphs corresponding to road portions. In some implementations, the local lane graph estimator 402 includes a vectorized local lane graph engine 414, which works to process input data and generate vectorized representations of local lane structures. The vectorized local lane graph engine 414 may include an image backbone 416 and a LiDAR backbone 418. The image backbone 416 may be configured to process images 422 received from cameras 424. In some implementations, the image backbone 416 may employ convolutional neural networks or other computer vision techniques to extract relevant features from the input images.

The LiDAR backbone 418 may process point cloud data 426 received from LiDAR sensors 428. In some implementations, the LiDAR backbone 418 may utilize point cloud processing algorithms to extract three-dimensional information about the surrounding environment. The outputs from the image backbone 416 and the LiDAR backbone 418 may be combined to generate birds-eye-view (BEV) features 430. These BEV features 430 may provide a top-down representation of the road structure and surrounding environment, which can be useful for accurate lane graph estimation.

A transformer decoder 420 within the local lane graph estimator 402 may process the BEV features 430 to generate local lane graphs 432. In some implementations, the transformer decoder 420 may employ attention mechanisms to focus on relevant parts of the input features and generate detailed lane structure information. The generation of the local lane graph may involve a structured modeling of map elements. Map elements, such as lane boundaries, road edges, and crosswalks, may be represented as point sets with a group of equivalent permutations. This permutation-equivalent modeling addresses the inherent ambiguity in defining the start point and direction of certain map elements, such as lane dividers and pedestrian crossings.

In some implementations, the vectorized local lane graph engine 414 may be configured to generate a vector representation of road environment based on the BEV feature outputs from the image backbone 416 and the LiDAR backbone 418. The vectorization process may include encoding the image and LiDAR point cloud data into a mathematical vector representation, which may be referred to as a local lane graph 432. The local lane graph 432 may represent road features at a specific location. In some implementations, the vectorized local lane graph engine 414 may be configured to generate local lane graphs 432 at regular intervals along a road segment.

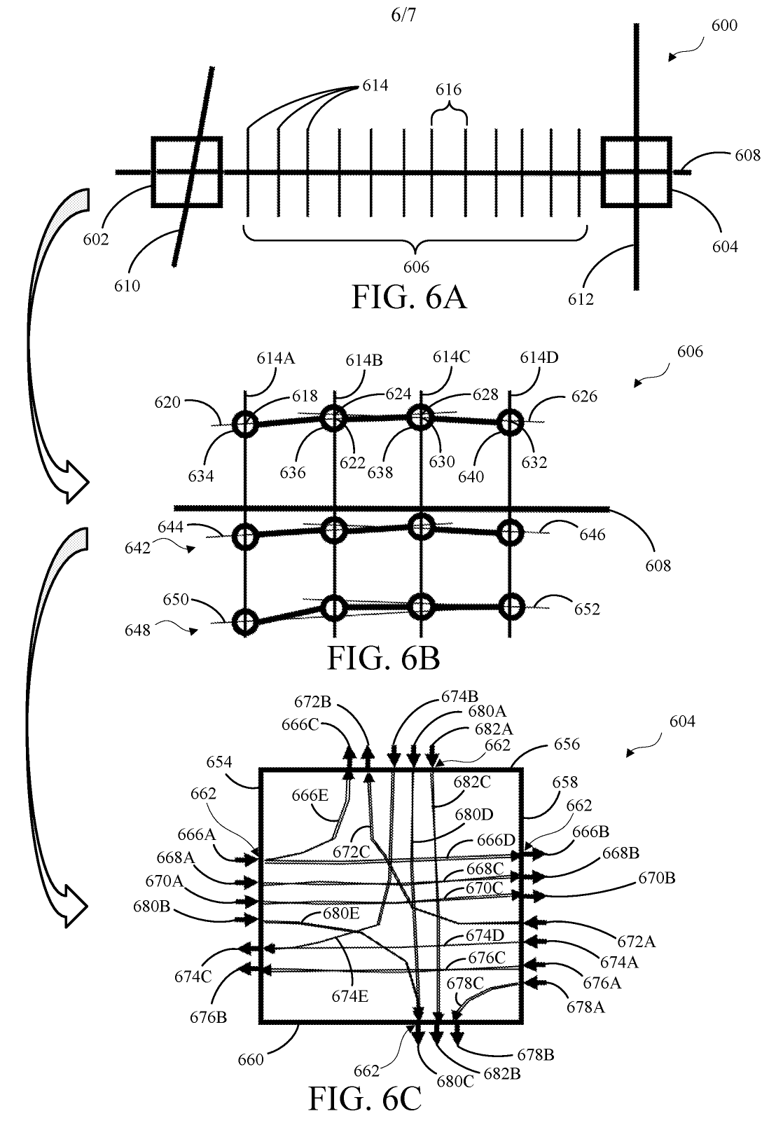

The local lane graphs 432 may be provided to the lane graph aggregator 406. In some implementations, the local lane graphs 432 may be aggregated from multiple vehicles, including the vehicle 210/211, before being transmitted to the lane graph aggregator 406. The lane graph aggregator 406 may be configured to generate a lane-level map 412 based on the local lane graphs 432. The lane-level map 412 may represent road features at a higher level of detail than the local lane graphs 432 provided by the local lane graph estimator 402. To achieve this, the local lane graph aggregator 406 may process the local lane graphs 432 as described herein with reference to FIGS. 6A-6C to aggregate the local lane graphs to generate a lane-level map 412. The term "lane-level map" may refer to any amount of lane-level map data.

The map embedding engine 404 may be configured to process and represent map data. For example, the map embedding engine 404 may generate embedded map representation of lane-level map data. The lane-level map 412 may be provided as input to the map embedding engine 404. In some implementations, the map embedding engine 404 may also receive a standard definition (SD) map 410 as input. This SD map 410 provides lower-resolution, basic road network information like road centerlines and intersections. In some implementations, the SD map 410 may serve as initial prior knowledge for the map embedding engine 404. In some implementations, the SD map 410 may serve as input in addition to the lane-level map 412. The map embedding engine 404 may operate in accordance with any number of processing approaches including, for example, a multi-pass approach.

The multi-pass approach refines and improves road structure estimation over time by using different map data sources in a sequence of processing steps. The idea is to use different levels of map information at different stages of the estimation process. This allows the system 400 to begin with broader, less detailed information, and then refine it using more specific, aggregated data. In some implementations, the SD map 410 may be used as an initial input to the map embedding engine 404 during a first pass. During the first pass, a coarse representation of road structure may be constructed based on the SD map 410. As shown, the map embedding engine 404 may include a polyline extractor 434 and a transformer encoder 436. The polyline extractor 434 may be configured to generate polylines 438 based on the SD map 410 during the first pass. The polylines 438 may represent the coarse road structures and may be used as an input to the transformer encoder 436. The transformer encoder 436 may be configured to provide road level structure estimation based on the polylines 438. For example, the transformer encoder 436 may generate intermediate lane graphs, which may be provided to the transformer decoder 420 of the vectorized local lane graph engine 414, as shown. In this way, the vectorized local lane graph engine 414 may generate local lane graphs 432 based on the BEV features 430 and the road level structure estimations generated by the transformer encoder 436.

In a second pass of the multi-pass approach, the lane-level map 412 may be used in addition to or in place of the SD map 410. The lane-level map 412 may provide road structure information at a higher level of detail than the polylines 438. The polylines 438, or a concatenation of the polylines 438 and the lane-level map 412, may be provided as an input to the transformer encoder 436. During the second pass, the polyline extractor 434 may extract polylines from the lane-level map 412 (and, in some cases, the SD map 410). The transformer encoder 436 may provide road level structure estimation based on the polylines generated from the lane-level map 412 (and, in some cases, the SD map 410). For example, the transformer encoder 436 may generate intermediate lane graphs, which may be provided to the transformer decoder 420 of the vectorized local lane graph engine 414, as shown. In this way, the vectorized local lane graph engine 414 may generate local lane graphs 432 based on the BEV features 430 and the road level structure estimations generated by the transformer encoder 436. In subsequent passes of the multi-pass approach, the output of the transformer encoder 436 may be fed back into the transformer decoder to refine the local lane graph structure for the road represented by the lane-level map 412. In some implementations, a localization component 408 may be included in the system to improve the output accuracy of the map embedding engine 404. For example, the localization component 408 may include a sensor suite, such as a LiDAR sensor 428, which may be mounted on a vehicle, such as vehicle 100 or vehicle 210 or vehicle 211. In some implementations, the localization component 408 may provide positional localization information to the map embedding engine 404. For example, the localization component 408 may utilize GPS, inertial measurement units, or other localization techniques to determine the precise location of the vehicle or sensing platform within the road network. The map embedding engine 404 may use this positional localization information to improve or refine the mapping of the road environment.

This iterative process allows for a self-improving mechanism. The initial estimation, guided by the SD map 410, leads to the creation of a lane-level map 412. This refined lane-level map 412 can then be used in subsequent estimations, either as a prior in the vectorized local lane graph engine 414 and/or as an input for further refinement by the map embedding engine 404. In some implementations, the SD map 410 may also be provided as additional input in the second pass and/or subsequent passes, alongside or in conjunction with the lane-level map 412. This allows the system 400 to combine the broad topological information from the SD map with the detailed lane information from the aggregated lane-level map for improved road structure understanding. The multi-pass approach aims to improve the accuracy and completeness of road structure estimation over time. By iteratively processing information and leveraging the strengths of different map data sources, the system 400 adapts to changes in the road environment without needing constant updates to a centralized, resource-intensive high-definition map.

In some implementations, the system 400 may also communicate with external data sources or services to incorporate additional information into the road structure estimation process. For example, the system may interface with cloud-based mapping services or receive updates from other vehicles to further improve the accuracy of its lane-level maps. The integration of multiple data sources and processing components in system 400 allows for robust and adaptive road structure estimation. By combining high-resolution sensor data with existing map information and employing advanced machine learning techniques, the system can generate detailed and up-to-date lane-level maps without relying solely on pre-existing high-definition maps.

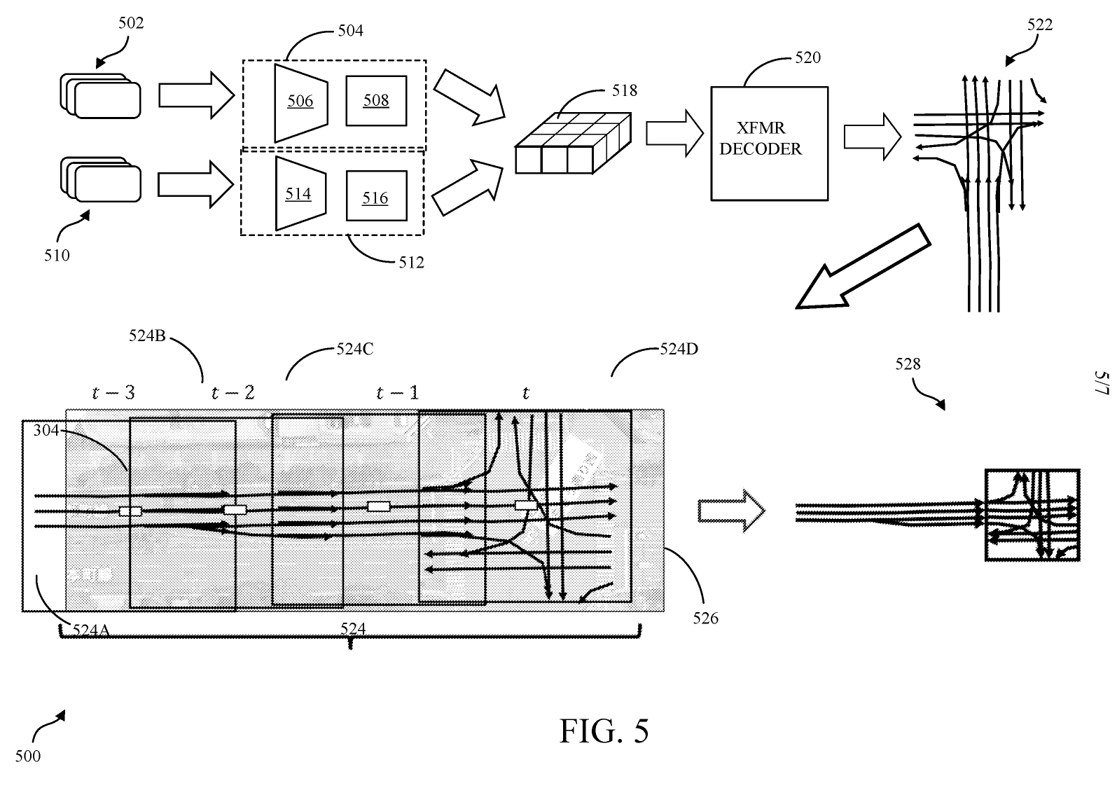

FIG. 5 is a diagram of an example of a data flow 500 for road structure estimation. In some implementations, one or more aspects of the data flow 500 may be performed by the system 400 described in FIG. 4.

The data flow 500 includes multiple processing paths for handling different types of input data. A first processing path receives images 502, which are processed through a map encoder 504. In some implementations, the images 502 may be captured by one or more cameras mounted on a vehicle or other mobile platform. The images 502 may include visual information about the surrounding road environment, including lane markings, road edges, and other relevant features.

The map encoder 504 is configured to process the input images 502 and extract relevant features for road structure estimation. In some implementations, the map encoder 504 may include a 2-dimensional (2D) backbone 506 and a perspective view (PV) to birds-eye-view (BEV) component 508. The 2D backbone 506 may be implemented as a convolutional neural network (CNN) or other suitable architecture for processing 2D image data. The 2D backbone 506 may extract features such as edge information, texture patterns, and other visual cues relevant to road structure.

The PV to BEV component 508 may be configured to transform the perspective view features extracted by the 2D backbone 506 into a birds-eye-view representation. This transformation may involve geometric transformations and feature warping to create a top-down view of the road structure. In some implementations, the PV to BEV component 508 may utilize learnable parameters to optimize the transformation process for road structure estimation tasks.

A second processing path in the data flow 500 receives a point cloud 510, which is processed through a map encoder 512. The point cloud 510 may be generated by LiDAR sensors or other depth-sensing devices mounted on the vehicle or mobile platform. The point cloud 510 provides three-dimensional information about the surrounding environment, which can be useful for accurately estimating road geometry and structure. The map encoder 512 includes a LiDAR backbone 514 and a sparse-to-dense component 516. The LiDAR backbone 514 is designed to process the input point cloud 510 and extract relevant features for road structure estimation. The sparse-to-dense component 516 may be configured to convert the sparse features extracted by the LiDAR backbone 514 into a dense representation that can be more easily combined with the image-based features. This process may involve techniques such as voxelization or continuous convolutions to create a regular grid of features from the irregular point cloud data.

The outputs from both processing paths are combined to generate birds-eye-view (BEV) features 518. In some implementations, the combination of image-based and LiDAR-based features may be performed through feature concatenation, element-wise addition, or more sophisticated fusion techniques such as attention mechanisms. The BEV features 518 provide a rich, multi-modal representation of the road environment that captures both visual and geometric information.

The BEV features 518 are provided as input to a transformer decoder 520 (shown as "XFMR decoder"), which is configured to generate a local lane graph 522 based on the fused features. In some implementations, the transformer decoder 520 may utilize self-attention and cross-attention mechanisms to process the BEV features 518 and generate a structured representation of the local road layout. The transformer architecture may facilitate efficient modeling of long-range dependencies in the feature space, which can be useful for understanding complex road structures.

The local lane graph 522 output by the transformer decoder 520 represents a vectorized description of the road structure in the immediate vicinity of the vehicle or sensing platform. This graph may include information about lane boundaries, centerlines, intersections, and other relevant road features. In some implementations, the local lane graph 522 may be represented as a set of nodes and edges, where nodes correspond to points in the road structure and edges represent connections between these points.

The system performing the data flow 500 processes a set 524 of multiple local lane graphs, which includes local lane graph 524A, local lane graph 524B, local lane graph 524C, and local lane graph 524D. These local lane graphs represent road structure information captured at different times or locations. By processing multiple local lane graphs, the system can build a more comprehensive and consistent representation of the road network over time.

In some implementations, the system may aggregate different types of sets of local lane graphs to enhance the accuracy and completeness of the road structure estimation. These sets may include local lane graphs generated from a single vehicle over multiple passes of the same road segment, providing temporal consistency and capturing changes in the environment. In some implementations, the system may aggregate local lane graphs from multiple vehicles traversing the same area, which can offer diverse perspectives and increase the robustness of the estimation. In some cases, the sets may include local lane graphs generated under various environmental conditions, such as different times of day, weather conditions, or seasons, allowing the system to adapt to dynamic changes in the road appearance. The system may also process sets of local lane graphs that cover different types of road structures, including urban streets, highways, and complex intersections, to build a comprehensive understanding of diverse road layouts. By aggregating these varied sets of local lane graphs, the system may be able to generate a more accurate and up-to-date lane-level map that reflects the current state of the road network across different scenarios and conditions.

In addition to the sensor-based processing paths, the system performing the data flow 500 also may process a standard definition map 526. The SD map 526 may include basic road network information such as road centerlines, intersections, and general road topology. In some implementations, the SD map 526 may be used to provide prior knowledge or constraints to guide the road structure estimation process.

The processed information from the local lane graphs and SD map is used to aggregate the local lane graphs to generate a lane-level map 528. This lane-level map 528 represents a more detailed and up-to-date representation of the road structure compared to the standard definition map. In some implementations, the lane-level map 528 may include precise lane boundaries, lane connectivity information, and other fine-grained details that are important for autonomous driving applications.

FIGS. 6A-6C are diagrams associated with a process for lane graph aggregation, in accordance with the present disclosure. In some implementations, one or more aspects of the process illustrated in FIGS. 6A-6C may be performed by the lane graph aggregator 406 described in FIG. 4 and may be, be similar to, include, or be included in the data flow shown in FIG. 5.

FIG. 6A shows an SD map 600 containing multiple road segments and intersections. The standard definition map 600 includes an intersection area 602, an intersection area 604, and an other road area 606 between the two intersection areas 602 and 604. The standard definition map 600 includes a drive lines 608, 610, and 612, which represent the general path of travel for vehicles on the road segments. In some implementations, these drive lines may be used as a reference for positioning way bars and estimating lane structures.

A set of way bars 614 is positioned along the other road area 606. Each way bar (e.g., way bar 614A, way bar 614B, way bar 614C, and way bar 614D) is placed perpendicular to the direction of travel at regular intervals 616. In some implementations, the interval 616 between way bars may be adjustable based on the desired granularity of the lane graph aggregation process. In some implementations, the interval 616 between way bars may vary depending on factors such as road type, desired level of detail, and computational resources available. For example, the interval 616 may be set to 5 meters for urban environments with complex road structures, allowing for more frequent sampling and higher resolution lane graph aggregation. In highway scenarios, where road geometry tends to be more consistent, the interval 616 may be increased to 10 or 20 meters to reduce computational overhead while still capturing essential road features.

In some cases, the system may employ adaptive interval sizing, where the interval 616 is dynamically adjusted based on the complexity of the road structure. For instance, the interval 616 may be reduced to 2-3 meters in areas with intricate lane configurations, such as merging lanes or complex intersections, while extending to 30-50 meters in long, straight road segments with minimal changes in lane structure. Some implementations may also allow for customizable interval settings, where users or system administrators can define the interval 616 based on specific application requirements. For example, a high-precision mapping project may use intervals as small as 1 meter, while a large-scale road network analysis may opt for larger intervals of 50-100 meters to cover extensive areas more efficiently.

FIG. 6B illustrates the process of identifying crossing points between local lane graphs and way bars. For example, the other road area 606 depicted in FIG. 6B includes way bars 614A, 614B, 614C, and 614D. A crossing point 618 is identified at which a local lane graph 620 crosses the way bar 614A. The local lane graph 620 also crosses the way bar 614B at a crossing point 622. At a crossing point 624, another local lane graph 626 crosses the way bar 614B. The local lane graph 620 crosses the way bar 614C at a crossing point 628 and, at a crossing point 630, the local lane graph 626 crosses the way bar 614C. At a crossing point 632, the local lane graph 626 crosses the way bar 614D.

Based on the identified crossing points, the lane graph aggregator determines centroids (e.g., centroid 634 corresponding to the crossing point 618, centroid 636 corresponding to the crossing points 622 and 624, centroid 638 corresponding to the crossing points 628 and 630, and centroid 640 corresponding to the crossing point 632. The lane graph aggregator may determine centroids based on the identified crossing points to create a more robust and consistent representation of the lane structure. In some implementations, the centroid determination process may involve statistical analysis of the crossing point distributions along each way bar. For example, the lane graph aggregator may apply clustering algorithms to group closely spaced crossing points, with the centroid representing the center of mass for each cluster. This approach may help mitigate the effects of noise or minor inconsistencies in individual local lane graphs. By calculating centroids, the system may effectively combine information from multiple local lane graphs, potentially improving the accuracy and reliability of the aggregated lane-level map. In some cases, the centroid determination process may also incorporate weighting factors based on the confidence levels associated with each local lane graph or the recency of the data, allowing the lane graph aggregator to prioritize more reliable or up-to-date information when constructing the aggregated representation of the road structure.

FIG. 6B shows an additional example 642 of crossing points and centroids identified in connection with a local lane graph 644 and a local lane graph 646. An additional example 648 shows identified crossing points and centroids associated with a local lane graph 650 and a local lane graph 652. In some implementations, the lane graph aggregator may determine any number of centroids based on identified crossing points.

FIG. 6C illustrates the process of handling of an intersection area 604. The intersection area 604 is defined by intersection area edges 654, 656, 658, and 660. In some implementations, these edges may be determined based on the geometry of the standard definition map or through analysis of the local lane graphs.

The lane graph aggregator identifies crossing points 662 where local lane graphs intersect with the intersection area edges. These crossing points are then used to determine input points (e.g., input points 666A, 668A, 670A, 672A, 674A, 674B, 676A, 678A, 680A, 680B, and 682A) and output points (e.g., output points 666B, 666C, 668B, 670B, 672B, 674C, 676B, 678B, 680C, and 682B) for the intersection.

Connections between input and output points are established based on the trajectories of the local lane graphs through the intersection. For example, connections 666D and 666E show two possible paths from input point 666A to output points 666B and 666C, respectively. In some implementations, the system may use probabilistic methods to determine the likelihood of different connections based on the frequency of observed trajectories in the local lane graphs. The process of creating connections within the intersection area continues with additional examples such as connection 670C between input point 670A and output point 670B, connections 674D and 674E from input points 674A and 674B to output point 674C, and connection 676C between input point 676A and output point 676B.

In some implementations, the system may also consider traffic rules and regulations when establishing connections within intersections. For example, certain turns or movements may be prohibited, and the lane graph aggregation process may account for these restrictions when creating the final lane-level map.

The lane graph aggregation process illustrated in FIGS. 6A-6C enables the creation of a comprehensive and consistent lane-level map by combining information from multiple local lane graphs. This approach may facilitate the generation of detailed road structure information without relying solely on high-definition maps or precise localization techniques. The resulting lane-level map can be used to enhance the capabilities of autonomous driving systems and advanced driver assistance features, providing a more accurate representation of the road environment.

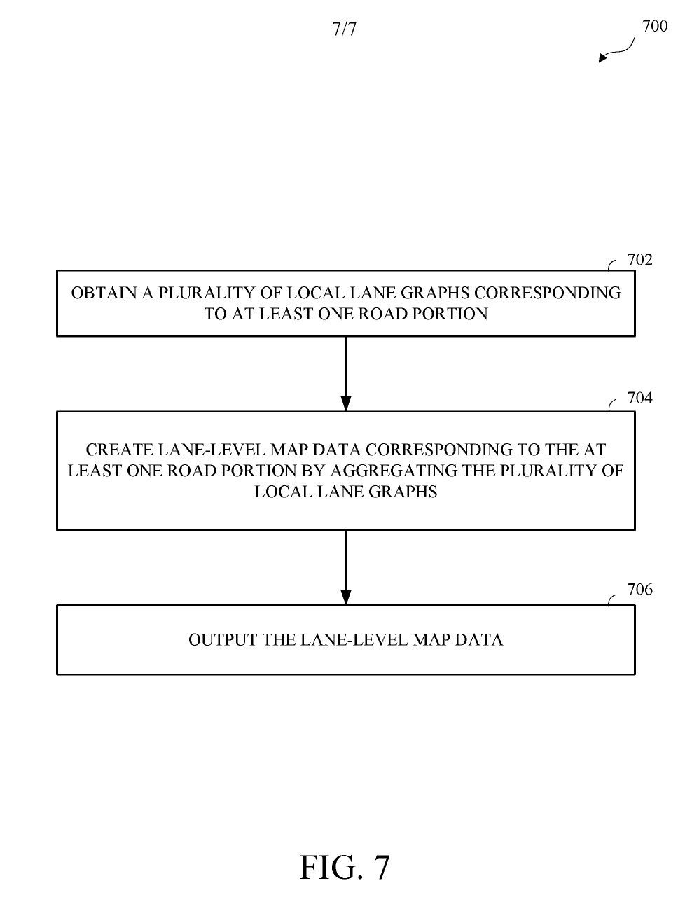

To further describe some implementations in greater detail, reference is next made to examples of techniques which may be performed by or using a system such as, for example, the system 400 shown in FIG. 4. FIG. 7 is a flowchart of an example of a technique 700 associated with road structure estimation. The technique 700 can be executed using computing devices, such as the systems, hardware, and software described with respect to FIGS. 1-6C. The technique 700 can be performed, for example, by executing a machine-readable program or other computer-executable instructions, such as routines, instructions, programs, or other code. The steps, or operations, of the technique 700, or another technique, method, process, or algorithm described in connection with the implementations disclosed herein can be implemented directly in hardware, firmware, software executed by hardware, circuitry, or a combination thereof.

For simplicity of explanation, the technique 700 is depicted and described herein as a series of steps or operations. However, the steps or operations of the technique 700 can occur in various orders and/or concurrently. Additionally, other steps or operations not presented and described herein may be used. Furthermore, not all illustrated steps or operations may be required to implement a technique in accordance with the disclosed subject matter.

At 702, the technique 700 may include obtaining a plurality of local lane graphs corresponding to at least one road portion. In some implementations, this step may be performed by a vectorized local lane graph engine (e.g., the vectorized local lane graph engine 414 shown in FIG. 4), which may be configured to generate the plurality of local lane graphs based on various input data sources. The local lane graphs may represent detailed information about the road structure, including lane boundaries, centerlines, and other relevant features.

In some implementations, the vectorized local lane graph engine may include components such as an image backbone and a LiDAR backbone. The image backbone may process images received from one or more cameras mounted on a vehicle or other mobile platform. These images may provide visual information about the surrounding road environment. The LiDAR backbone may process point cloud data (e.g., a point clous) received from LiDAR sensors, providing three-dimensional information about the road structure and surrounding objects. The vectorized local lane graph engine may combine the processed image and LiDAR data to generate BEF features. These BEV features may provide a top-down representation of the road structure and surrounding environment. In some implementations, a transformer decoder within the vectorized local lane graph engine may process the BEV features to generate the local lane graphs.

At 704, the technique 700 may include creating lane-level map data (e.g., a lane-level map) corresponding to the at least one road portion by aggregating the plurality of local lane graphs. This step may be performed by a lane graph aggregator (e.g., the lane graph aggregator 406 shown in FIG. 4), which may be configured to process and combine multiple local lane graphs to create a more comprehensive and consistent lane-level map.

The lane graph aggregation process may involve several sub-steps. In some implementations, the process may begin by dividing a portion of a standard definition map into an intersection area and an other road area. The lane graph aggregator may then identify a first set of local lane graphs associated with the intersection area and a second set of local lane graphs associated with the other road area. For the intersection area, the lane graph aggregator may create a first lane-level map portion by identifying subsets of local lane graphs that cross the edges of the intersection area. The lane graph aggregator may then identify a set of input points and corresponding output points associated with the intersection area based on these subsets. In some implementations, a clustering algorithm may be applied to determine the input and output points.

For the other road area, the lane graph aggregator may create a second lane-level map portion by generating a set of way bars. These way bars may be placed perpendicular to the direction of travel at regular intervals along the road. The lane graph aggregator may then identify crossing points where local lane graphs intersect with the way bars. In some implementations, the lane graph aggregator may determine centroids for clusters of crossing points on each way bar and connect these centroids to form a continuous lane representation.

At 706, the technique 700 may include outputting the lane-level map data. In some implementations, this step may involve providing a lane-level map to other components of the road structure estimation system or to external systems that may use this information for various purposes, such as autonomous driving or advanced driver assistance features.

In some implementations, the lane-level map data may be output to a map embedding engine (e.g., the map embedding engine 404 shown in FIG. 4) configured to generate a global lane graph. A global lane graph is a consistent lane-level map. The map embedding engine may employ techniques such as graph neural networks or other machine learning approaches to create and update a global map representation based on the aggregated lane graphs.

The technique 700 may also include additional steps or variations in some implementations. For example, the system may provide a standard definition map as input to the map embedding engine. This standard definition map may contain basic road network information such as road centerlines and intersections. In some implementations, the standard definition map may be provided as an initial input during a first pass, while the lane-level map data is output in a second pass after the first pass.

In some implementations, the technique 700 may involve a multi-pass approach to refine and improve road structure estimation over time. For example, after outputting the lane-level map data, the system may feed this information back into the vectorized local lane graph engine. A transformer decoder within the vectorized local lane graph engine may receive the embedded map representation as input and generate a new set of local lane graphs based on this representation and the BEV features.

This iterative process may facilitate continually improving road structure estimation capabilities. As more data is processed and incorporated into the global map, the accuracy and completeness of the lane-level map data can be enhanced over time. This approach may be particularly useful for adapting to changes in the road environment without requiring constant updates to a centralized high-definition map.

The technique 700 may be implemented using various hardware and software configurations. For example, the system may include one or more memories and one or more processors configured to execute instructions stored in the memories. These instructions may cause the system to instantiate the various components described above, such as the vectorized local lane graph engine, the lane graph aggregator, and the map embedding engine.

In some implementations, the technique 700 may be performed by an apparatus for road structure estimation. This apparatus may include one or more memories and one or more processors configured to execute instructions stored in the memories to perform the steps of obtaining the plurality of local lane graphs, creating the lane-level map data, and outputting the lane-level map data.

The technique 700 provides a flexible and adaptive approach to road structure estimation that can be used in various applications, such as autonomous driving systems and advanced driver assistance features. By combining information from multiple local lane graphs and incorporating both sensor data and existing map information, the technique allows for the creation of detailed and up-to-date lane-level maps without relying solely on high-definition maps or precise localization techniques.

Some implementations include a method for road structure estimation, comprising: obtaining a plurality of local lane graphs corresponding to at least one road portion; creating lane-level map data corresponding to the at least one road portion by aggregating the plurality of local lane graphs; and outputting the lane-level map data.

In some implementations, outputting the lane-level map data comprises outputting the lane-level map data to a map embedding engine configured to generate an embedded map representation of a global map.

In some implementations, the method further comprises: receiving, by a transformer decoder of a vectorized local lane graph engine configured to generate the plurality of local lane graphs, the embedded map representation of the global lane graph as input; and generating, by the transformer decoder of the vectorized local lane graph engine, the plurality of local lane graphs based on the embedded map representation of the global lane graph and a set of birds-eye-view (BEV) features.

In some implementations, the method further comprises providing, to the map embedding engine, a standard definition map as input.

In some implementations, providing the standard definition map as input to the map embedding engine comprises providing the standard definition map as an initial input to the map embedding engine during a first pass, wherein outputting the lane-level map data comprises providing the lane-level map data as an output in a second pass after the first pass.

In some implementations, the method further comprises providing, in the second pass, the standard definition map as additional input to the map embedding engine.

In some implementations, aggregating the plurality of local lane graphs comprises: dividing a portion of a standard definition map into an intersection area and an other road area; identifying a first set of local lane graphs of the plurality of local lane graphs associated with the intersection area and a second set of local lane graphs of the plurality of local lane graphs associated with the other road area; creating a first lane-level map portion corresponding to the intersection area based on the first set of local lane graphs; and creating a second lane-level map portion corresponding to the other road area based on the second set of local lane graphs.

In some implementations, creating the first lane-level map portion comprises: identifying a plurality of subsets of the first set of local lane graphs, wherein each subset of the plurality of subsets of the first set of local lane graphs comprises one or more local lane graphs of the first set of local lane graphs that cross a respective edge of the intersection area; identifying a set of input points and a set of corresponding output points associated with the intersection area based on the plurality of subsets of the first set of local lane graphs; and generating the first lane-level map portion based on the set of input points and the set of output points.

In some implementations, identifying the set of input points and the set of output points comprises applying a clustering algorithm to the plurality of subsets of the first set of local lane graphs.

In some implementations, creating the second lane-level map portion comprises: generating a set of way bars in the second lane-level map portion corresponding to the other road area; identifying a set of crossing points, each crossing point of the set of crossing points corresponding to a crossing of a local lane graph of the second set of local lane graphs and a way bar of the set of way bars; and generating the second lane-level map portion based on the set of crossing points.

In some implementations, the method further comprises: identifying, for a first way bar of the set of way bars, a first cluster of crossing points corresponding to the first way bar; determining a first centroid point for the first cluster of crossing points; identifying, for a second way bar of the set of way bars, a second cluster of crossing points corresponding to the second way bar; determining a second centroid point for the second cluster of crossing points; and determining a path between the first centroid point and the second centroid point.

Some implementations include a system for road structure estimation, comprising: one or more memories; and one or more processors configured to execute instructions stored in the one or more memories to cause the system to: instantiate a vectorized local lane graph engine configured to generate a plurality of local lane graphs corresponding to at least one road portion; instantiate a lane graph aggregator configured to create lane-level map data corresponding to the at least one road portion by aggregating the plurality of local lane graphs; and output the lane-level map data.

In some implementations, the one or more processors are configured to execute the instructions to further cause the system to instantiate a map embedding engine configured to generate a embedded map representation of a global map, wherein the one or more processors are configured to output the lane-level map data to the map embedding engine.

In some implementations, the one or more processors are configured to execute the instructions to further cause the system to: receive, by a transformer decoder of the vectorized local lane graph engine, the embedded map representation of the global lane graph as input; and generate, by the transformer decoder of the vectorized local lane graph engine, the plurality of local lane graphs based on the embedded map representation of the global lane graph and a set of BEV features.

In some implementations, the one or more processors are configured to execute the instructions to further cause the system to provide, to the map embedding engine, a standard definition map as input.

In some implementations, the one or more processors are configured to execute the instructions to further cause the system to provide the standard definition map as an initial input to the map embedding engine during a first pass, wherein the one or more processors are configured to output the lane-level map data by providing the lane-level map data as an output in a second pass after the first pass.

Some implementations include an apparatus for road structure estimation, comprising: one or more memories; and one or more processors configured to execute instructions stored in the one or more memories to cause the apparatus to: obtain a plurality of local lane graphs corresponding to at least one road portion; create lane-level map data corresponding to the at least one road portion by aggregating the plurality of local lane graphs; and output the lane-level map data.

In some implementations, the one or more processors are configured to execute the instructions to further cause the apparatus to output the lane-level map data to a map embedding engine configured to generate an embedded map representation of a global map.

In some implementations, the one or more processors are configured to execute the instructions to further cause the apparatus to provide, to the map embedding engine, a standard definition map as input.

In some implementations, the one or more processors are configured to execute the instructions to further cause the apparatus to provide the standard definition map as an initial input to the map embedding engine during a first pass, wherein the one or more processors are configured to output the lane-level map data by providing the lane-level map data as an output in a second pass after the first pass.

The foregoing disclosure provides illustration and description but is not intended to be exhaustive or to limit the aspects to the precise forms disclosed. Modifications and variations may be made in light of the above disclosure or may be acquired from practice of the aspects. As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein.

As used herein, the terminology “instructions” may include directions or expressions for performing any technique, or any portion or portions thereof, disclosed herein, and may be realized in hardware, software, or any combination thereof. For example, instructions may be implemented as information, such as a computer program, stored in memory that may be executed by a processor to perform any of the respective methods, algorithms, aspects, techniques, or combinations thereof, as described herein. Instructions, or a portion thereof, may be implemented as a special purpose processor, or circuitry, that may include specialized hardware for carrying out any of the techniques, algorithms, aspects, or combinations thereof, as described herein. In some implementations, portions of the instructions may be distributed across multiple processors on a single device, on multiple devices, which may communicate directly or across a network such as a local area network, a wide area network, the Internet, or a combination thereof.

As used herein, the terminology “example”, “embodiment”, “implementation”, “aspect”, “feature”, or “element” indicates serving as an example, instance, or illustration. Unless expressly indicated, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “determine” and “identify”, or any variations thereof, includes selecting, ascertaining, computing, looking up, receiving, determining, establishing, obtaining, or otherwise identifying or determining in any manner whatsoever using one or more of the devices shown and described herein. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, the terminology "or" is intended to mean an inclusive “or” rather than an exclusive “or” and may be used interchangeably with “and/or,” unless explicitly stated otherwise (for example, if used in combination with “either” or “only one of”), or clearly is used otherwise from context. In addition, the articles “a” and “an” as used in this application and the appended claims should generally be construed to mean “one or more” unless specified otherwise or clear from context to be directed to a singular form. Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” As used herein, a phrase referring to “at least one of” a list of items refers to any combination of those items, including single members. As an example, “at least one of: a, b, or c” is intended to cover a, b, c, a + b, a + c, b + c, and a + b + c, as well as any combination with multiples of the same element (for example, a + a, a + a + a, a + a + b, a + a + c, a + b + b, a + c + c, b + b, b + b + b, b + b + c, c + c, and c + c + c, or any other ordering of a, b, and c).

Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Accordingly, unless explicitly stated otherwise, the phrase “based on” is intended to mean “based at least in part on.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set. Further, for simplicity of explanation, although the figures and descriptions herein may include sequences or series of steps or stages, elements of the techniques disclosed herein may occur in various orders or concurrently. Additionally, elements of the techniques disclosed herein may occur with other elements not explicitly presented and described herein. Furthermore, not all elements of the techniques described herein may be required to implement a technique in accordance with this disclosure. Although aspects, features, and elements are described herein in particular combinations, each aspect, feature, or element may be used independently or in various combinations with or without other aspects, features, and elements.

The above-described aspects, examples, and implementations have been described in order to allow easy understanding of the disclosure are not limiting. On the contrary, the disclosure covers various modifications and equivalent arrangements included within the scope of the appended claims, which scope is to be accorded the broadest interpretation so as to encompass all such modifications and equivalent structure as is permitted under the law.

What is claimed is:

1. A method for road structure estimation, comprising:
obtaining a plurality of local lane graphs corresponding to at least one road portion;
creating lane-level map data corresponding to the at least one road portion by aggregating the plurality of local lane graphs; and
outputting the lane-level map data.

2. The method of claim 1, wherein outputting the lane-level map data comprises outputting the lane-level map data to a map embedding engine configured to generate a global lane graph comprising an embedded map representation of a global map.

3. The method of claim 2, further comprising:
receiving, by a transformer decoder of a vectorized local lane graph engine configured to generate the plurality of local lane graphs, the embedded map representation of the global lane graph as input; and
generating, by the transformer decoder of the vectorized local lane graph engine, the plurality of local lane graphs based on the embedded map representation of the global lane graph and a set of birds-eye-view (BEV) features.

4. The method of claim 2, further comprising providing, to the map embedding engine, a standard definition map as input.

5. The method of claim 4, wherein providing the standard definition map as input to the map embedding engine comprises providing the standard definition map as an initial input to the map embedding engine during a first pass, wherein outputting the lane-level map data comprises providing the lane-level map data as an output in a second pass after the first pass.

6. The method of claim 5, further comprising providing, in the second pass, the standard definition map as additional input to the map embedding engine.

7. The method of claim 1, wherein aggregating the plurality of local lane graphs comprises:
dividing a portion of a standard definition map into an intersection area and an other road area;
identifying a first set of local lane graphs of the plurality of local lane graphs associated with the intersection area and a second set of local lane graphs of the plurality of local lane graphs associated with the other road area;
creating a first lane-level map portion corresponding to the intersection area based on the first set of local lane graphs; and
creating a second lane-level map portion corresponding to the other road area based on the second set of local lane graphs.

8. The method of claim 7, wherein creating the first lane-level map portion comprises:
identifying a plurality of subsets of the first set of local lane graphs, wherein each subset of the plurality of subsets of the first set of local lane graphs comprises one or more local lane graphs of the first set of local lane graphs that cross a respective edge of the intersection area;
identifying a set of input points and a set of corresponding output points associated with the intersection area based on the plurality of subsets of the first set of local lane graphs; and
generating the first lane-level map portion based on the set of input points and the set of corresponding output points.

9. The method of claim 8, wherein identifying the set of input points and the set of corresponding output points comprises applying a clustering algorithm to the plurality of subsets of the first set of local lane graphs.

10. The method of claim 7, wherein creating the second lane-level map portion comprises:
generating a set of way bars in the second lane-level map portion corresponding to the other road area;
identifying a set of crossing points, each crossing point of the set of crossing points corresponding to a crossing of a local lane graph of the second set of local lane graphs and a way bar of the set of way bars; and
generating the second lane-level map portion based on the set of crossing points.

11. The method of claim 10, further comprising:
identifying, for a first way bar of the set of way bars, a first cluster of crossing points corresponding to the first way bar;
determining a first centroid point for the first cluster of crossing points;
identifying, for a second way bar of the set of way bars, a second cluster of crossing points corresponding to the second way bar;
determining a second centroid point for the second cluster of crossing points; and
determining a path between the first centroid point and the second centroid point.

12. A system for road structure estimation, comprising:
one or more memories; and
one or more processors configured to execute instructions stored in the one or more memories to cause the system to:
instantiate a vectorized local lane graph engine configured to generate a plurality of local lane graphs corresponding to at least one road portion;
instantiate a lane graph aggregator configured to create lane-level map data corresponding to the at least one road portion by aggregating the plurality of local lane graphs; and
output the lane-level map data.

13. The system of claim 12, wherein the one or more processors are configured to execute the instructions to further cause the system to instantiate a map embedding engine configured to generate a global lane graph comprising an embedded map representation of a global map, wherein the one or more processors are configured to output the lane-level map data to the map embedding engine.

14. The system of claim 13, wherein the one or more processors are configured to execute the instructions to further cause the system to:
receive, by a transformer decoder of the vectorized local lane graph engine, the embedded map representation of the global lane graph as input; and
generate, by the transformer decoder of the vectorized local lane graph engine, the plurality of local lane graphs based on the embedded map representation of the global lane graph and a set of birds-eye-view (BEV) features.

15. The system of claim 13, wherein the one or more processors are configured to execute the instructions to further cause the system to provide, to the map embedding engine, a standard definition map as input.

16. The system of claim 15, wherein the one or more processors are configured to execute the instructions to further cause the system to provide the standard definition map as an initial input to the map embedding engine during a first pass, wherein the one or more processors are configured to output the lane-level map data by providing the lane-level map data as an output in a second pass after the first pass.

17. An apparatus for road structure estimation, comprising:
one or more memories; and
one or more processors configured to execute instructions stored in the one or more memories to cause the apparatus to:
obtain a plurality of local lane graphs corresponding to at least one road portion;
create lane-level map data corresponding to the at least one road portion by aggregating the plurality of local lane graphs; and
output the lane-level map data.

18. The apparatus of claim 17, wherein the one or more processors are configured to execute the instructions to further cause the apparatus to output the lane-level map data to a map embedding engine configured to generate an embedded map representation of a global map.

19. The apparatus of claim 18, wherein the one or more processors are configured to execute the instructions to further cause the apparatus to provide, to the map embedding engine, a standard definition map as input.

20. The apparatus of claim 19, wherein the one or more processors are configured to execute the instructions to further cause the apparatus to provide the standard definition map as an initial input to the map embedding engine during a first pass, wherein the one or more processors are configured to output the lane-level map data by providing the lane-level map data as an output in a second pass after the first pass.
